(19) United States
(12) Patent Application Publication
(10) Pub. No.: US 2020/0001323 A1
(43) Pub. Date: Jan. 2, 2020

(54) DECORATIVE COATING FILM

(71) Applicant: TOYOTA JIDOSHA KABUSHIKI KAISHA, Toyota-shi (JP)

(72) Inventor: Fumitaka YOSHINAGA, Toyota-shi (JP)

(73) Assignee: TOYOTA JIDOSHA KABUSHIKI KAISHA, Toyota-shi (JP)

(21) Appl. No.: 16/559,697

(22) Filed: Sep. 4, 2019

Related U.S. Application Data
(63) Continuation of application No. 15/030,725, filed on Apr. 20, 2016.

(30) Foreign Application Priority Data
Oct. 24, 2013 (JP) 2013-221071

(51) Int. Cl. B05D 1/00; C09D 5/38

(52) U.S. Cl. CPC B05D 1/005; C09D 5/38

(57) ABSTRACT

A decorative coating film formed on a surface of a resinous base placed on a path of electromagnetic waves of a radar device. The decorative coating film includes fine particles of a silver alloy dispersed in the decorative coating film; and a light-transmissive binder resin with which the fine particles of a silver alloy are bonded. The silver alloy consists of an alloy of silver and zinc, and the zinc is contained in an amount of 0.5 to 50 mass % relative to the silver.

This application is a continuation of U.S. application Ser. No. 15/030,725 filed Apr. 20, 2016, which is a National Stage of International Application No. PCT/IB2014/002156, filed Oct. 20, 2014, which claims priority from JP 2013-221071 filed Oct. 24, 2019; the entire content of which is incorporated herein by reference.

### BACKGROUND OF THE INVENTION

### 1. Field of the Invention

The invention relates to a decorative coating film formed on the surface of a resinous base, and more particular, relates to a decorative coating film that is excellent in terms of resistance to discoloration.

### 2. Description of Related Art

Some vehicles including motor vehicles are each equipped with a radar device, e.g., a millimeter-wave radar, mounted at the center of the front part thereof, in order to measure the distance between the vehicle and any obstacle or vehicle present ahead. The radio waves, e.g., millimeter waves, radiating ahead from the radar device through the front grille and the emblem of the vehicle manufacturer are reflected by objects such as vehicles or obstacles in front of the vehicle, and the reflected waves return to the radar device through the front grille, etc.

Hence, materials and coating materials, which are reduced in radio wave transmission loss and can impart a desired attractive appearance, are frequently used for members or components, e.g., a front grille and an emblem, located within the path of beams from the radar device. Generally, decorative coating films have been formed on the surface of resinous bases.

Meanwhile, silver coating films have been used in various applications because the films have a high visible light transmittance and excellent infrared-shielding properties. Furthermore, since silver coating films further have excellent radio wave-shielding properties, the films, for example, can protect electronic appliances which may suffer a malfunction due to radio waves, from external radio waves or can inhibit electronic appliances from radiating radio waves. There are hence cases where silver coating films are used as coating films for shielding radio waves.

For example, Japanese Patent Application Publication No. 2004-263290 (JP 2004-263290 A) discloses a silver alloy film for shielding radio waves which contains 0.01 to 10 at % bismuth (Bi) and/or antimony (Sb). This silver alloy film for shielding radio waves has been covered with a transparent dielectric coating film. The document mentions that even when this coating film develops defects such as pinholes or scratches to make the silver alloy film directly exposed, silver aggregation is less apt to occur.

However, when silver is applied in order to heighten design attractiveness, for example, to the surface of a resinous base, e.g., an emblem to be located within the path of beams from a radar device, for example, in such a manner that the resinous base is coated with a silver coating film as shown in JP 2004-263290 A, then the radio waves, such as millimeter waves, emitted from the radar device come not to penetrate easily therethrough. In view of this, for example, using fine particles of silver and a binder resin for bonding these fine particles to form a decorative coating film on the base surface would be conceived.

In such cases, however, the decorative coating film containing fine silver particles discolors with the lapse of time even when these fine silver particles in the decorative coating film are not directly exposed to the air. Even when fine particles of a silver alloy including silver and Bi added thereto were used in such decorative coating film, the discoloration was not able to be sufficiently inhibited.

### SUMMARY OF THE INVENTION

The invention provides a decorative coating film which has been formed on the surface of a resinous base to be located within the path of beams from a radar device and which can be sufficiently inhibited from discoloring although containing fine particles of a silver alloy.

The inventors diligently made investigations and, as a result, obtained a finding that the surface of fine particles of either silver or an ordinary silver alloy is affected by surface plasmon resonance absorption, resulting in discoloration of the decorative coating film. Namely, as shown in FIG. 12A, when fine particles of silver or a silver alloy are irradiated with light, then the fine particles vibrate due to the energy of the light to make free electrons inside the fine particles move, thereby polarizing the fine particles of silver or a silver alloy. Thus, as shown in FIG. 12B, surface electromagnetic waves called surface plasmon/polariton generate on the surface of the fine particles of silver or a silver alloy to absorb light having a specific wavelength, thereby increasing the energy of the fine particles of silver or a silver alloy (surface plasmon resonance absorption). As a result, constituent substances around the fine particles of silver or a silver alloy receive the increased energy to discolor the decorative coating film; this is the new finding. The inventors hence thought that it is important to select a specific silver alloy which is less apt to cause the surface plasmon resonance absorption even when in the state of fine particles, which are prone to cause such resonance absorption.

A first aspect of the invention relates to a decorative coating film formed on a surface of a resinous base to be located within the path of beams from a radar device. The decorative coating film includes fine particles of a silver alloy which have been dispersed in the decorative coating film and a light-transmissive binder resin with which the fine particles of a silver alloy are bonded, wherein the silver alloy includes an alloy of silver and zinc, the zinc being contained in an amount of 0.5 to 50 mass % relative to the silver.

A second aspect of the invention relates to a decorative coating film formed on a surface of a resinous base placed on a path of electromagnetic waves of a radar device. The decorative coating film includes fine particles of a silver alloy dispersed in the decorative coating film and a light-transmissive binder resin with which the fine particles of a silver alloy are bonded, wherein the silver alloy includes an alloy of silver and nickel, the nickel being contained in an amount of 1 to 30 mass % relative to the silver.

Since these decorative coating films have a structure which at least includes fine particles of a silver alloy that have been dispersed in the decorative coating film and a light-transmissive binder resin with which the fine particles of a silver alloy are bonded, the decorative coating films retain a metallic glossy appearance and have radio wave-transmitting properties (electrical insulating properties).

According to the first and second aspects, the fine particles of a silver alloy consisting of either a silver-zinc alloy satisfying the above-mentioned alloying proportion or a silver-nickel alloy satisfying the above-mentioned alloying proportion are more effective in inhibiting the decorative coating film from changing in color as compared with fine particles of other silver alloys.

In a case where the silver alloy according to the first aspect contains zinc in an amount less than 0.5 mass % of the silver or in a case where the silver alloy according to the second aspect contains nickel in an amount less than 1 mass % of the silver, the decorative coating film may discolor because the proportion of the silver in the silver alloy is too high.

Meanwhile, in a case where the silver alloy according to the first aspect contains zinc in an amount exceeding 50 mass % of the silver or in a case where the silver alloy according to the second aspect contains nickel in an amount exceeding 30 mass % of the silver, the brightness of the decorative coating film decreases as the zinc or nickel content increases.

The fine silver alloy particles according to the first and second aspects may have an average particle diameter of 2 to 200 nm. In a case where the fine silver alloy particles have an average particle diameter larger than 200 nm, the fine silver alloy particles are prone to cause irregular reflection. It has been found that due to this irregular reflection, the silver gloss is prone to decrease. For this reason, a desirable range of the average particle diameter of the silver alloy is up to 200 nm. Meanwhile, in a case where the fine silver alloy particles have an average particle diameter less than 2 nm, the light striking upon the decorative coating film is less apt to be reflected.

In particular, although fine silver alloy particles having a size on the order of nanometer are prone to absorb light due to the phenomenon called localized surface plasmon resonance absorption, the fine silver alloy particles satisfying the alloying proportion according to the first or second aspect can be inhibited from absorbing light energy. Consequently, the decorative coating films can be inhibited from changing in color although fine silver alloy particles of such size are used.

The silver alloys according to the first and second aspects may have a crystallite diameter in the range of 2 to 98 nm. In a case where the crystallite diameter thereof is less than 2 nm, the light striking upon the decorative coating films is less apt to be reflected. Meanwhile, in a case where the crystallite diameter thereof is larger than 98 nm, radio waves (electromagnetic waves) are less apt to penetrate the decorative coating films.

The inventors presume that in the first aspect, the peripheral surface of the fine particles consisting of an alloy of silver and zinc is coated with zinc oxide, which has higher resistance than the binder resin (resin matrix), to thereby inhibit the binder resin (resin matrix) from altering and from causing a change in color. Meanwhile, the inventors presume that in the second aspect, the fine particles consisting of an alloy of silver and nickel inhibit surface plasmon resonance absorption and, hence, the resin matrix is inhibited from altering and from causing a change in color.

According to the invention, a decorative coating film which has been formed on the surface of a resinous base to be located within the path of beams from a radar device can be sufficiently inhibited from discoloring even when fine silver alloy particles are used.

### BRIEF DESCRIPTION OF THE DRAWINGS

Features, advantages, and technical and industrial significance of an exemplary embodiment of the invention will be described below with reference to the accompanying drawings, in which like numerals denote like elements, and wherein:

FIG. 1 is a schematic view which illustrates a decorative coating film according to an embodiment of the invention;

FIG. 2 is a schematic view for illustrating the configuration of the decorative coating film shown in FIG. 1;

FIG. 3 is a schematic view which shows a relationship among a front grille (resinous base) disposed in the front of a vehicle, an emblem disposed on a surface thereof, and a radar device disposed behind the resinous base and inside the vehicle;

FIG. 4 is a schematic view which shows a relationship among a front grille (resinous base) disposed in the front of a vehicle, an emblem disposed on a surface thereof, and a radar device disposed behind the resinous base and inside the vehicle;

FIG. 5 is a presentation which shows a relationship between the alloying proportion (Zn/Ag) of zinc in the silver alloys according to Examples 1 to 4 and Comparative Examples 1 and 2 and the color difference ΔE of decorative coating films formed using these;

FIG. 6 is a presentation which shows a relationship between the alloying proportion (Zn/Ag) of zinc in the silver alloys according to Examples 1 to 6 and Comparative Examples 1 to 3 and the initial value of L* (before a weathering test) of decorative coating films formed using these;

FIG. 7 is a presentation which shows a relationship between the alloying proportion (Zn/Ag) and the initial value of L* in the zinc-silver alloys of Example 7 and a relationship between the alloying proportion (Bi/Ag) and the initial value of L* in the Bi-silver alloys of Comparative Example 4;

FIG. 8 is a presentation which shows a relationship between the decorative coating films according to Examples 8 and 9 and Comparative Examples 5 to 7, which were obtained using fine silver alloy particles, and color difference ΔE;

FIG. 9 is a presentation which shows a relationship between the wavelength of light incident upon the decorative coating films according to Examples 8 and 9 and Comparative Examples 5 to 7, which were obtained using fine silver alloy particles, and the reflectance of the decorative coating films;

FIG. 10 is a presentation which shows a relationship between the decorative coating films according to Examples 10 to 13 and Comparative Examples 8 and 9, which were obtained using fine silver alloy particles, and color difference ΔE;

FIG. 11 is a presentation which shows a relationship between the wavelength of light incident upon the decorative coating films according to Example 10 and Comparative Example 8, which were obtained using fine silver alloy particles, and the reflectance of the decorative coating films;

FIG. 12A is a set of views for illustrating how a fine silver alloy particle is polarized by light; and

FIG. 12B is a view for illustrating surface plasmon resonance absorption.

### DETAILED DESCRIPTION OF EMBODIMENT

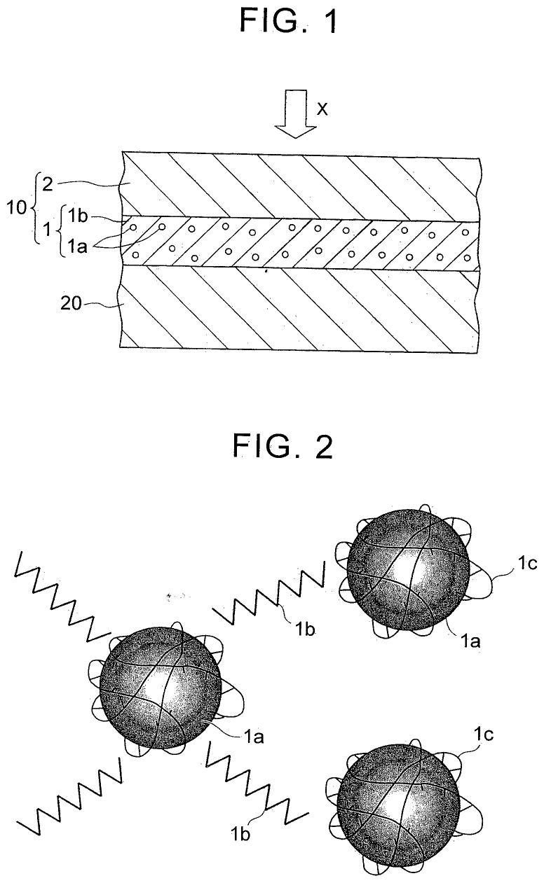

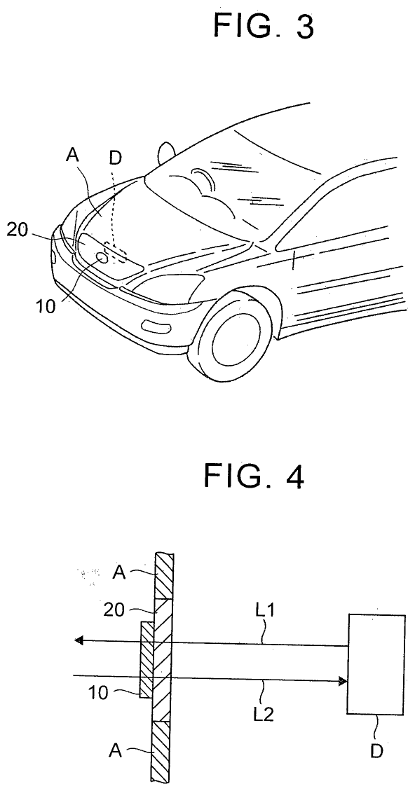

FIG. 1 is a schematic view which illustrates an embodiment of the decorative coating films of the invention. FIG. 2 is a schematic view for illustrating the configuration of the decorative coating film shown in FIG. 1. FIG. 3 is a schematic view which shows a relationship among a front grille (resinous base) disposed in the front of a vehicle, an emblem disposed on a surface of the front grille, and a radar device disposed behind the resinous base and inside the vehicle. FIG. 4 is a schematic view which shows a relationship among a front grille (resinous base) disposed in the front of a vehicle, an emblem disposed on a surface of the front grille, and a radar device disposed behind the resinous base and inside the vehicle.

The decorative coating film 10 shown in FIG. 1 constitutes an emblem to be mounted on a surface of a resinous base 20 which is a front grille. As shown in FIG. 3, a radar device D to be mounted in the front of a vehicle body A is disposed behind the front grille. Millimeter waves (millimeter waves L1) emitted from the radar device D radiate ahead through the front grille and the emblem disposed on the surface thereof, as shown in FIG. 4, and are reflected by objects such as vehicles or obstacles in front of the vehicle. The reflected waves (millimeter waves L2) return to the radar device D through the emblem and the front grille. Thus, the decorative coating film 10 (emblem) is formed on a surface of the resinous base 20 to be located within the path of radar-device beams.

Since the decorative coating film 10 is applied to a surface of a resinous base 20 (front grille) to be located within the path of radar-device beams, the coating film retains a metallic glossy appearance and has the radio wave-transmitting properties (electrical insulating properties).

Specifically, as shown in FIG. 1, the decorative coating film 10 has been configured as a whole by superposing a bright layer 1 and a transparent resinous coating layer 2 along the direction from which the decorative coating film 10 is viewed (direction X). Incidentally, the decorative coating film 10 may be one in which a sticker or the like has been applied to the bright layer 1 and the sticker is bonded to the resinous base 20. The bright layer 1 at least includes fine silver alloy particles 1a dispersed in the decorative coating film and a light-transmissive binder resin 1b with which the fine silver alloy particles 1a are bonded, as shown in FIG. 2. More preferably, a dispersant (protective agent) 1c has been further added to the bright layer 1 in order to heighten the dispersibility of the fine silver alloy particles 1a.

In the bright layer 1 of the decorative coating film 10, the fine silver alloy particles have been discontinuously dispersed in the layer as stated above, and the particle-to-particle distance are extremely short because the silver alloy is nanoparticles. The particles hence have densely gathered. Consequently, the nanoparticles provide a metallic glossy appearance to the human eyes, whereas radio waves pass through the nanoparticles with extremely slight millimeter-wave attenuation. As a result, the coating film can retain a metallic glossy appearance and have electrical insulating properties.

Incidentally, the term “millimeter waves” used herein means radio waves which have a frequency band of about 30 to 300 GHz, for example, millimeter waves having a frequency of about 76 GHz in the frequency band. The term “decorative coating film” used herein means an element for constituting the above-mentioned emblem of a vehicle manufacturer, a decorative article characteristics of the vehicle, or the like. An emblem or the like which is constituted of this decorative coating film or which includes the decorative coating film as a part thereof is formed on a surface of a front grille which is a resinous base.

In the embodiment, the silver alloy constituting the fine silver alloy particles 1a is an alloy of silver and zinc and contains zinc in an amount in the range of 0.5 to 50 mass % of the silver. In another aspect, the silver alloy constituting the fine silver alloy particles 1a is an alloy of silver and nickel and contains nickel in an amount in the range of 1 to 30 mass % of the silver.

The fine particles of a silver alloy consisting of either a silver-zinc alloy satisfying the above-mentioned alloying proportion (Zn/Ag: 0.5 to 50 mass %) or a silver-nickel alloy satisfying the above-mentioned alloying proportion (Ni/Ag: 1 to 30 mass %), as stated above, are more effective in inhibiting the decorative coating film from changing in color as compared with fine particles of other silver alloys, as seen from the experiments made by the inventors which will be described later.

In a case where the silver alloy contains zinc in an amount less than 0.5 mass % of the silver or in a case where the silver alloy contains nickel in an amount less than 1 mass % of the silver, the decorative coating film may discolor because the proportion of the silver in the silver alloy is too high.

Meanwhile, in a case where the silver alloy contains zinc in an amount exceeding 50 mass % of the silver or in a case where the silver alloy contains nickel in an amount exceeding 30 mass % of the silver, the brightness of the decorative coating film decreases.

Here, the term “fine particles” used for silver alloys in the embodiment means “nanoparticles”, and the “nanoparticles” are particles which have an average particle diameter on the order of nanometer. Examples of methods for determining the particle diameter of nanoparticles include a method in which the metal particles present in a certain area in a scanning electron microscope (SEM) image or transmission electron microscope (TEM) image of the fine particles of a silver alloy are extracted on the image and an average particle diameter of the extracted particles is determined.

In particular, although fine silver alloy particles having a size on the order of nanometer are prone to absorb light due to the phenomenon called localized surface plasmon resonance absorption, the fine silver alloy particles satisfying the above-mentioned alloying proportion of zinc or nickel are inhibited from absorbing light energy. Consequently, the decorative coating films can be inhibited from changing in color although fine silver alloy particles of such size are used.

It is desirable that the fine silver alloy particles should have an average particle diameter of 2 to 200 nm regardless of whether the silver alloy is a zinc- or nickel-silver alloy. In a case where the fine silver alloy particles have an average particle diameter larger than 200 nm, the fine silver alloy particles are prone to cause irregular reflection whereby silver gloss is prone to decrease. Meanwhile, in a case where the fine silver alloy particles have an average particle diameter less than 2 nm, the light striking upon the decorative coating film is less apt to be reflected.

Furthermore, it is preferable that the silver alloy should have a crystallite diameter in the range of 2 to 98 nm. In a case where the crystallite diameter thereof is less than 2 nm, the light striking upon the decorative coating film is less apt to be reflected. Meanwhile, in a case where the crystallite diameter thereof exceeds 98 nm, radio waves (electromagnetic waves) are less apt to penetrate the decorative coating film.

Such fine silver alloy particles can be produced, for example, by introducing a reducing agent into an ionic solution in which silver and either zinc or nickel, which each alloys with silver, are in an ionic state. The fine particles obtained by such production method are particles of a size on the order of nanometer.

The composition of the alloy of silver and either zinc or nickel can be controlled by changing the amounts of the metals to be contained in the ionic solution. After a reducing agent is introduced into the ionic solution in which silver and either zinc or nickel have been ionized, this solution is stirred. By controlling the time period over which the ionic solution is stirred and by controlling the heating temperature therefor, the average particle diameter of the fine silver alloy particles and the crystallite diameter of the silver alloy can be regulated.

The resinous coating layer 2 and the binder resin 1b are light-transmissive polymer resins. Examples thereof include acrylic resins, polycarbonate resins, poly(ethylene terephthalate) resins, epoxy resins, and polystyrene resins.

In cases when a dispersant (protective agent) 1c is added, the dispersant (protective agent) 1c is preferably a resin which has good adhesion to the fine silver alloy particles 1a and good affinity for the binder resin 1b. In the case where any of the binder resins shown above as examples has been selected, the resin into which carbonyl groups have been incorporated is preferred. For example, in the case where an acrylic resin has been selected as the binder resin 1b, it is preferable that an acrylic resin having carbonyl groups be selected as the dispersant (protective agent) 1c.

Such a dispersant (protective agent) which has carbonyl groups can have enhanced adhesion to the fine silver alloy particles 1a. Furthermore, by selecting the same resin as the binder resin 1b, the affinity for the binder resin 1b can be enhanced.

It is preferable that the content of the fine silver alloy particles 1a in the entire bright layer 1 should be 83 to 99 mass %. In a case where the content thereof is less than 83 mass %, there are cases where the metallic gloss due to the fine silver alloy particles 1a is insufficient. In a case where the content thereof exceeds 99 mass %, there are cases where the adhesion to the base due to the binder resin 1b is insufficient.

The invention will be explained below by reference to Examples.

### Example 1

Silver nitrate was mixed in an amount of 220 g with 3.84 g of zinc nitrate so that the proportion (alloying proportion: content percentage) of the zinc in the fine silver alloy particles to be produced is 1 mass % relative to the silver. This mixture was added to 597 g of an amino alcohol (reducing agent), and the ingredients were thereafter heated and mixed at 60° C. for 120 minutes to precipitate fine silver alloy particles. The resultant mixture was subjected to ultrafiltration at room temperature for 3 hours (average particle diameter of the fine particles, 50 nm; crystallite diameter of the silver alloy, 10 nm).

Next, mixture 1 was prepared by mixing, as ingredients, 40 g of propylene glycol monoethyl ether, 8.86 g of styrene, 8.27 g of ethylhexyl acrylate, 15 g of lauryl methacrylate, 34.8 g of 2-hydroxyethyl methacrylate, 3.07 g of methacrylic acid, 30 g of acid phosphoxyhexamonomethacrylate, 43 g of a polymerization initiator for the propylene glycol monoethyl ether, and 0.3 g of t-butyl peroctoate. A 0.465-g portion of mixture 1 was mixed with 0.38 g of Disperbyk 190 (manufactured by BYK Japan KK), 0.23 g of Epocros WS-300 (manufactured by NIPPON SHOKUBAI CO., LTD.), 0.09 g of BYK-330 (manufactured by BYK Japan KK), and 150 g of 1-ethoxy-2-propanol to prepare a coating material. The coating material was mixed as a binder resin with the fine silver alloy particles. Subsequently, the obtained mixture was applied by spin coating and heat-treated at 80° C. for 30 minutes. Thus, a decorative coating film was formed.

### Examples 2 to 7

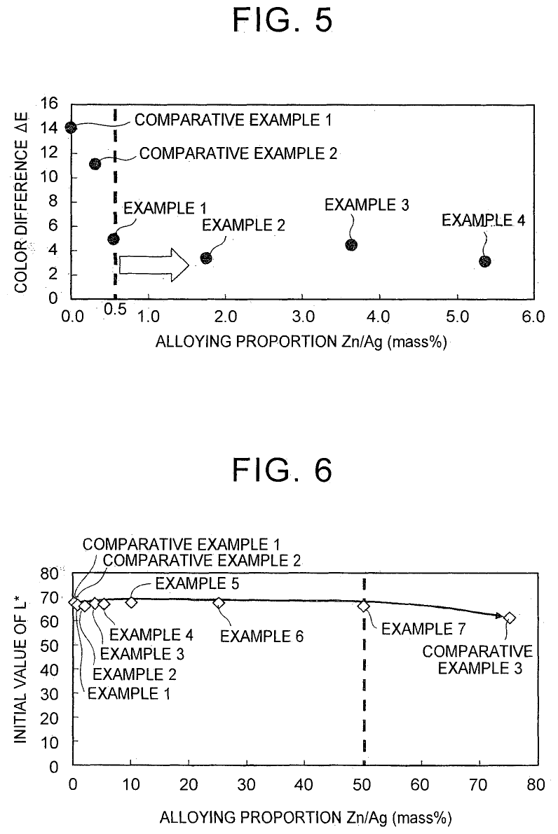

Decorative coating films were formed in the same manner as in Example 1. Examples 2 to 7 differ from Example 1 in that the mixing ratio of silver nitrate and zinc nitrate was changed so as to result in the alloying proportions shown in FIG. 5 or 6.

### Comparative Examples 1 to 3

Decorative coating films were formed in the same manner as in Example 1. Comparative Example 1 differs from Example 1 in that zinc nitrate was not added, while Comparative Examples 2 and 3 differ therefrom in that the mixing ratio of silver nitrate and zinc nitrate was changed so as to result in the alloying proportions shown in FIG. 5 or 6.

[Weatherability Test (Xenon Test)]

The decorative coating films according to Examples 1 to 4 and Comparative Examples 1 to 3 were subjected to a weatherability test (xenon test) (100 W×125 MJ/m²). Before and after the weatherability test, the decorative coating films according to Examples 1 to 4 and Comparative Examples 1 to 3 were examined, with a color and color-difference meter (CMS-35sp, manufactured by MURAKAMI COLOR RESEARCH LABOLATORY, INC.), for brightness L* and chromaticness indices a* and b* according to the color system (L*, a*, b*) as provided for in CIE1976 color system (JIS Z8729). The color difference ΔE of each decorative coating film was calculated from these values.

FIG. 5 is a presentation which shows a relationship between the alloying proportion (Zn/Ag) of zinc in the silver alloys according to Examples 1 to 4 and Comparative Examples 1 and 2 and the color difference ΔE of decorative coating films formed using the alloys. FIG. 6 is a presentation which shows a relationship between the alloying proportion (Zn/Ag) of zinc in the silver alloys according to Examples 1 to 7 and Comparative Examples 1 to 3 and the initial value of L* (before the weatherability test) of decorative coating films formed using the alloys.

(Result 1)

As shown in FIG. 5, the color differences between before and after the weatherability test of the decorative coating films of Examples 1 to 4 were smaller than those of the decorative coating films of Comparative Examples 1 and 2. In the case of the silver alloys containing zinc in an amount less than 0.5 mass % relative to the silver (including the case where no zinc is contained), the decorative coating films discolor (change in color).

As shown in FIG. 6, the initial values of L* of the decorative coating films of Examples 1 to 7 were higher than that of the decorative coating film of Comparative Example 3. The results reveal that in the case of the alloy containing zinc in an amount exceeding 50 mass % relative to the silver, the brightness of the decorative coating film decreases.

### Example 7

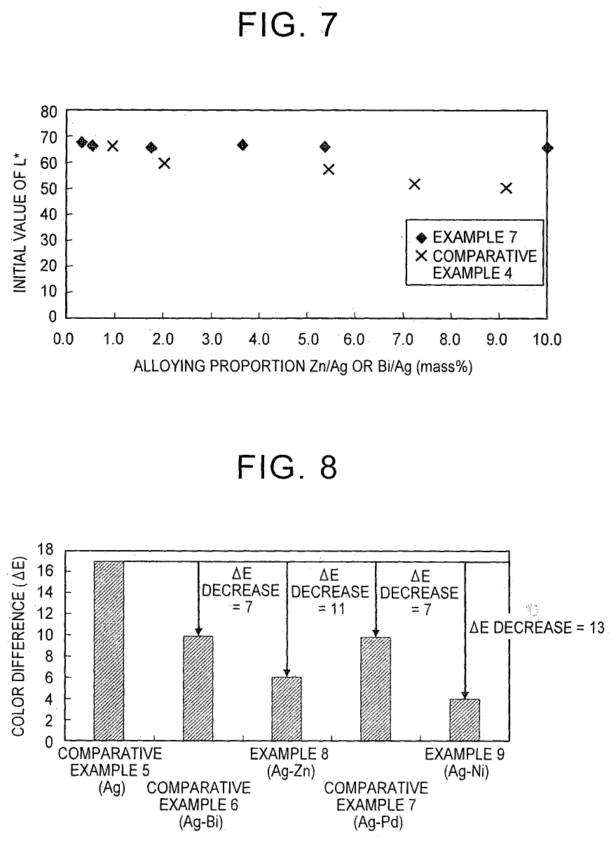

Decorative coating films were formed in the same manner as in Example 1. Example 7 differs from Example 1 in that the mixing ratio of silver nitrate and zinc nitrate was changed so as to result in the alloying proportions shown in FIG. 7.

### Comparative Example 4

Decorative coating films were formed in the same manner as in Example 1. Comparative Example 4 differs from Example 1 in that Bi nitrate was used in place of the zinc nitrate to produce fine particles consisting of an alloy of silver and Bi and that the mixing ratio of silver nitrate and Bi nitrate was changed so as to result in the alloying proportions shown in FIG. 7.

[Measurement of Initial Value of L*]

The decorative coating films according to Example 7 and Comparative Example 4 were examined for initial value of L* in the same manner as in Example 1. FIG. 7 is a presentation which shows a relationship between the alloying proportion (Zn/Ag) and the initial value of L* in the zinc-silver alloys of Example 7 and a relationship between the alloying proportion (Bi/Ag) and the initial value of L* in the Bi-silver alloys of Comparative Example 4.

(Result 2)

As shown in FIG. 7, the decorative coating films of Example 7 decreased little in initial value of L* even when the alloying proportion was increased. Meanwhile, the decorative coating films of Comparative Example 4 decreased in initial value of L* and became more yellowish as the alloying proportion was increased.

### Example 8

The same decorative coating film as in Example 1 was formed.

### Example 9

A decorative coating film was formed in the same manner as in Example 1. Example 9 differs from Example 1 in that nickel nitrate was used in place of the zinc nitrate to produce fine particles consisting of an alloy of silver and nickel (fine particles containing nickel in an amount of 1 mass % relative to the silver).

### Comparative Example 5

The same decorative coating film as in Comparative Example 1 was formed.

### Comparative Examples 6 and 7

Decorative coating films were formed in the same manner as in Example 8. Comparative Example 6 differs from Example 8 in that Bi nitrate was used in place of the zinc nitrate to produce fine particles consisting of an alloy of silver and Bi, while Comparative Example 7 differs therefrom in that palladium nitrate was used in place of the zinc nitrate to produce fine particles consisting of an alloy of silver and palladium.

The decorative coating films according to Examples 8 and 9 and Comparative Examples 5 to 7 were subjected to a weatherability test (xenon test) in the same manner as in Example 1, and the color differences ΔE thereof were calculated. FIG. 8 is a presentation which shows a relationship between the decorative coating films according to Examples 8 and 9 and Comparative Examples 5 to 7, which were obtained using fine silver alloy particles, and color difference ΔE.

[Determination of Reflectance]

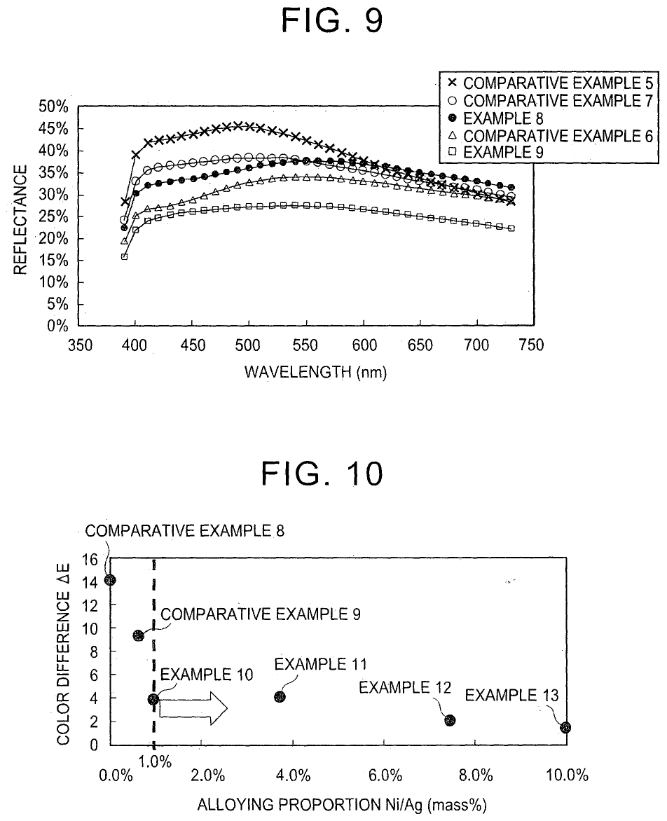

Before the weatherability test, the decorative coating films according to Examples 8 and 9 and Comparative Examples 5 to 7 were irradiated with light. From the resultant spectra of these decorative coating films, the reflectances of the decorative coating films at each wavelength were determined. FIG. 9 is a presentation which shows a relationship between the wavelength of light incident upon the decorative coating films according to Examples 8 and 9 and Comparative Examples 5 to 7, which were obtained using fine silver alloy particles, and the reflectance of the decorative coating films.

(Result 3)

As shown in FIG. 8, the decorative coating films of Example 8 and Example 9 had smaller color differences ΔE than those of Comparative Examples 5 to 7. As shown in FIG. 9, the decorative coating films of Comparative Examples 5 to 7 changed more in reflectance with changing wavelength as compared with those of Examples 8 and 9.

(Discussion 1)

As FIG. 9 shows, the decorative coating films of Comparative Examples 5 to 7 changed more in reflectance with changing wavelength as compared with those of Examples 8 and 9. This indicates that when the fine particles of silver or a silver alloy according to Comparative Examples 5 to 7 were irradiated with light, light components having specific wavelengths were absorbed. The energy of the fine particles of silver or a silver alloy was thought to be increased thereby (surface plasmon resonance absorption). It is thought that as a result, as shown in FIG. 8, constituent substances around the fine particles of silver or a silver alloy received the increased energy to discolor the decorative coating films. Meanwhile, it is thought that in the case of Examples 8 and 9 and Examples 1 to 7, which were given above, the surface plasmon resonance absorption was inhibited and, hence, constituent substances around the fine alloy particles were inhibited from receiving the energy generated by continuous irradiation with light, thereby rendering the decorative coating films able to be inhibited from changing in color. From a further analysis by the inventors, it is presumed that the peripheral surface of the fine particles consisting of an alloy of silver and zinc is coated with zinc oxide, which has higher resistance than the binder resin (resin matrix), and the binder resin (resin matrix) is hence inhibited from altering and from causing a change in color. Meanwhile, it is presumed that the fine particles consisting of an alloy of silver and nickel inhibit surface plasmon resonance absorption and, hence, the binder resin (resin matrix) is inhibited from altering and from causing a change in color.

### Examples 10 to 14

Decorative coating films were formed in the same manner as in Example 1. Examples 10 to 14 differ from Example 1 in that nickel nitrate was used in place of the zinc nitrate to produce fine particles consisting of an alloy of silver and nickel and that the mixing ratio of silver nitrate and nickel nitrate was changed so as to result in the alloying proportions (content percentage of Ni) shown in Table 1.

### Comparative Examples 8 to 11

Decorative coating films were formed in the same manner as in Example 10. Comparative Example 8 differs from Example 10 in that nickel nitrate was not added, while Comparative Examples 9 to 11 differ therefrom in that the mixing ratio of silver nitrate and nickel nitrate was changed so as to result in the alloying proportions shown in Table 1.

The decorative coating films according to Examples 10 to 13 and Comparative Examples 8 and 9 were subjected to a weatherability test (xenon test) in the same manner as in Example 1, and the color differences ΔE thereof were calculated. FIG. 10 is a presentation which shows a relationship between the decorative coating films according to Examples 10 to 13 and Comparative Examples 8 and 9, which were obtained using fine silver alloy particles, and color difference ΔE.

Before the weatherability test, the decorative coating films according to Examples 10 to 14 and Comparative Examples 9 to 11 were examined for initial value of L* in the same manner as in Example 1. The results thereof are shown in Table 1. Also shown in Table 1 are the results of a visual examination of metallic glossiness (mirror surface).

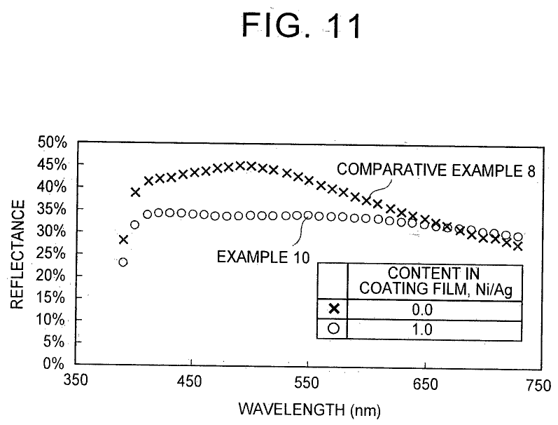

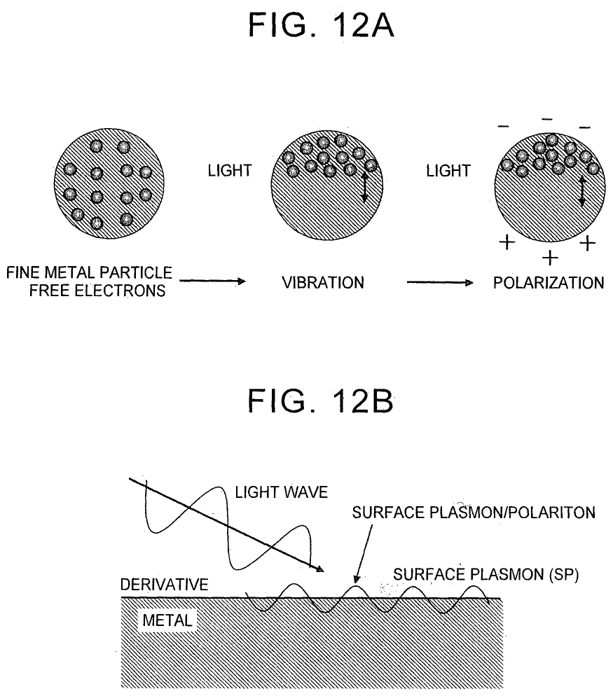

Before the weatherability test, the decorative coating films according to Example 10 and Comparative Example 8 were irradiated with light by the same method as in the above-mentioned determination of reflectance. From the resultant spectra of these decorative coating films, the reflectances of the decorative coating films at each wavelength were determined. FIG. 11 is a presentation which shows a relationship between the wavelength of light incident upon the decorative coating films according to Example 10 and Comparative Example 8, which were obtained using fine silver alloy particles, and the reflectance of the decorative coating films.

TABLE 1

| | Alloying | | |
|---|---|---|---|
| | proportion Ni/Ag | Initial | Metallic |
| | (mass %) | value of L* | gloss |
| Comparative Example 9 | 0.6 | 66.64 | present |
| Example 10 | 1.0 | 65.08 | present |
| Example 11 | 3.8 | 57.34 | present |
| Example 12 | 7.5 | 52.13 | present |
| Example 13 | 10.0 | 49.47 | present |
| Example 14 | 30.0 | 35.31 | present |
| Comparative Example 10 | 40.0 | 28.25 | absent |
| Comparative Example 11 | 50.0 | 25.73 | absent |

(Result 4)

As shown in FIG. 10, the color differences between before and after the weatherability test of the decorative coating films of Examples 10 to 13 were smaller than those of the decorative coating films of Comparative Examples 8 and 9. In the case of the silver alloys containing nickel in an amount less than 1.0 mass % relative to the silver (including the case where no nickel is contained), the decorative coating films discolor.

Meanwhile, as shown in Table 1, the initial values of L* of the decorative coating films of Examples 10 to 14 were higher than those of the decorative coating films of Comparative Examples 10 and 11. These results show that in the case of the silver alloys containing nickel in an amount exceeding 30 mass % relative to the silver, the decorative coating films decrease in brightness. As shown in FIG. 11, the decorative coating film of Comparative Example 8 changes more in reflectance with changing wavelength as compared with that of Example 10.

(Discussion 2)

It is thought that as shown in FIGS. 10 and 11, in the case of fine particles consisting of an alloy of silver and nickel, the surface plasmon resonance absorption was inhibited and, hence, constituent substances around the fine alloy particles were inhibited from receiving energy during continuous irradiation with light (the binder resin was inhibited from altering), thereby rendering the decorative coating films able to be inhibited from changing in color.

### Example 15

A decorative coating film was formed in the same manner as in Example 1. Example 15 differs from Example 1 in that the heating temperature at which the silver nitrate, zinc nitrate, and amino alcohol were mixed together and the mixing time therefor were changed to produce fine silver alloy particles that had an average particle diameter of 200 nm. Incidentally, the metal particles present in a certain area in a TEM image of the fine silver alloy particles were extracted on the image, and an average particle diameter of the extracted particles was determined.

### Comparative Example 12

A decorative coating film was formed in the same manner as in Example 15. Comparative Example 12 differs from Example 15 in that the temperature at which the silver nitrate, zinc nitrate, and amino alcohol were heated and the mixing time therefor were changed to produce fine silver alloy particles that had an average particle diameter of 500 nm.

(Result 5)

The decorative coating films of Example 15 and Comparative Example 12 were examined and, as a result, it was found that in the coating film of Comparative Example 12 (in which the fine silver alloy particles had an average particle diameter larger than 200 nm), the fine silver alloy particles caused irregular reflection and the silver gloss thereof was prone to be lower than that of the coating film of Example 15. It is preferable, also from the results of crystallite diameter examination which will be described later, that the average particle diameter be 2 nm or larger.

### Example 16

Decorative coating films were formed in the same manner as in Example 1. Example 16 differs from Example 1 in that the heating temperature at which the silver nitrate, zinc nitrate, and amino alcohol were mixed together and the mixing time therefor were changed to produce silver alloys that had crystallite diameters in the range of 2 to 98 nm (specifically, crystallite diameters of 2 nm, 25 nm, and 98 nm). Incidentally, the crystallite diameter of each silver alloy was determined by the X-ray diffraction method as provided for in JIS H7805.

### Comparative Example 13

Decorative coating films were formed in the same manner as in Example 16. Comparative Example 13 differs from Example 16 in that the temperature at which the silver nitrate, zinc nitrate, and amino alcohol were heated and the mixing time therefore were changed to produce silver alloys that had crystallite diameters less than 2 nm or greater than 98 nm (specifically, crystallite diameters of 1 nm and 99 nm).

(Result 6) The decorative coating films of Example 16 and Comparative Example 13 were examined and, as a result, it was found that in the case of the coating film of Comparative Example 13 in which the crystallite diameter was less than 2 nm, the light striking thereon was less apt to be reflected. Meanwhile, in the case of the coating film of Comparative Example 13 in which the crystallite diameter exceeded 98 nm, radio waves (electromagnetic waves) were less apt to be transmitted by the decorative coating film. The decorative coating films of Example 16 had metallic glossiness and satisfactory radio wave-transmitting properties.

While the embodiment of the invention have been described in detail with reference to the drawings, specific configurations thereof are not limited to the embodiment. Any design modifications or the like within the spirit of the invention will be included in the invention.

1. A front part of a vehicle, comprising:
a radar device that emits a millimeter-wave;
a front grille; and
a decorative coating film formed on a surface of a resinous base placed on a path of millimeter-wave of a radar device,
the decorative coating film comprising: (a) fine particles of a silver alloy dispersed in the decorative coating film; and (b) a light-transmissive binder resin with which the fine particles of the silver alloy are bonded,
wherein the silver alloy essentially consists of an alloy of silver and nickel, the nickel being contained in an amount of 1 to 30 mass % relative to the silver,
the light-transmissive binder resin is an acrylic resin, a polycarbonate resin, a poly(ethylene terephthalate) resin, an epoxy resin, or a polystyrene resin,
the decorative coating film has an electrical insulating property, and
the millimeter-wave is able to penetrate through the decorative coating film.

2. A front part of a vehicle, comprising:
a radar device that emits a millimeter-wave;
a front grille; and
a decorative coating film formed on a surface of a resinous base placed on a path of millimeter-wave of a radar device,
the decorative coating film comprising: (a) fine particles of a silver alloy dispersed in the decorative coating film; and (b) a light-transmissive binder resin with which the fine particles of the silver alloy are bonded,
wherein the silver alloy essentially consists of an alloy of silver and zinc, the zinc being contained in an amount of 0.5 to 50 mass % relative to the silver,
the light-transmissive binder resin is an acrylic resin, a polycarbonate resin, a poly(ethylene terephthalate) resin, an epoxy resin, or a polystyrene resin,
the decorative coating film has an electrical insulating property, and
the millimeter-wave is able to penetrate through the decorative coating film.

3. The front part of a vehicle according to claim 1, wherein the fine particles of the silver alloy have an average particle diameter of 2 to 200 nm.

4. The front part of a vehicle according to claim 1, wherein the silver alloy has a crystallite diameter in a range of 2 to 98 nm.

5. The front part of a vehicle according to claim 2, wherein the fine particles of the silver alloy have an average particle diameter of 2 to 200 nm.

6. The front part of a vehicle according to claim 2, wherein the silver alloy has a crystallite diameter in a range of 2 to 98 nm.

7. The front part of a vehicle according to claim 1, wherein the decorative coating film further includes a dispersant.

8. The front part of a vehicle according to claim 2, wherein the decorative coating film further includes a dispersant.

9. The front part of a vehicle according to claim 7, wherein the dispersant is an acrylic resin having carbonyl groups.

10. The front part of a vehicle according to claim 8, wherein the dispersant is an acrylic resin having carbonyl groups.

11. The front part of a vehicle according to claim 1, wherein the decorative coating film is an emblem.

12. The front part of a vehicle according to claim 2, wherein the decorative coating film is an emblem.
